(19) United States
(12) Patent Application Publication
(10) Pub. No.: US 2026/0274687 A1
(43) Pub. Date: Sep. 17, 2026

(54) METHOD FOR CONTROLLING THE PROPERTIES OF BIOGENIC SILICA THROUGH INTEGRATED THERMAL AND OXIDATIVE PROCESSING

(71) Applicant: KILT, LLC, Jonesboro, AR (US)

(72) Inventor: Larry W. Shipley, Jonesboro, AR (US)

(73) Assignee: KILT, LLC, Jonesboro, AR (US)

(21) Appl. No.: 19/679,183

(22) Filed: May 15, 2026

Related U.S. Application Data
(63) Continuation-in-part of application No. 18/186,328, filed on Mar. 20, 2023, now abandoned.
Application No. 18/186,328 is a continuation of application No. 16/549,667, filed on Aug. 23, 2019, now Pat. No. 11,618,684.
(60) Provisional application No. 63/850,092, filed on Jul. 24, 2025.
(60) Provisional application No. 63/850,078, filed on Jul. 24, 2025.
(60) Provisional application No. 62/830,054, filed on Apr. 5, 2019.
(60) Provisional application No. 62/727,183, filed on Sep. 5, 2018.

(51) Int. Cl. C01B 33/12; B09B 3/40; B09B 3/80

(52) U.S. Cl. CPC C01B 33/124; B09B 3/40; B09B 3/80; C01P 2002/02; C01P 2006/12; C01P 2006/14; C01P 2006/16

(57) ABSTRACT

A method for producing porous amorphous biogenic silica from siliceous plant matter through a three-element control architecture. Removal of non-siliceous inorganic flux constituents is maintained as a safety constraint preventing flux-induced sintering, crystallization, and pore collapse. Calcination temperature serves as the primary control variable, determining temperature-history-dependent surface-area plateaus in the range of 200-500 m²/g based on the complete thermal profile including ramp rate, peak temperature, and hold time. Peroxide-mediated oxidative intensity serves as a secondary variable applied only during pre calcination oxidative treatment and governs carbon-pathway partitioning between in-situ combustion and peroxide-mediated pre-volatilization of organic carbon away from silica structures, wherein higher peroxide intensity reduces the molecular weight of carbon compounds so they volatilize before combustion, thereby avoiding localized overheating at carbon-silica interfaces and preserving the native pore structure. The resulting silica exhibits an expanded dispersibility continuum including in-compound breakup, wherein particles undergo further dispersion during mechanical incorporation into matrices.

### CROSS-REFERENCE TO RELATED APPLICATIONS

This patent application is a continuation-in-part application of U.S. Application 18/186,328, filed March 20, 2023, which is a continuation application of U.S. Application 16/549,667, now issued as U.S. Patent 11,618,684, filed August 23, 2019, which is related to and claims the benefit of priority of U.S. Provisional Application 62/830,054, filed April 5, 2019, and is further related to and claims the benefit of priority of U.S. Provisional Application 62/727,183, filed September 5, 2018. This patent application is also related to and claims the benefit of priority of U.S. Provisional Application 63/850,078, filed July 24, 2025, and is further related to and claims the benefit of priority of U.S. Provisional Application 63/850,092, filed July 24, 2025. The entire contents of these applications are incorporated by reference herein.

### FIELD OF THE INVENTION

The present invention relates generally to methods for producing porous amorphous biogenic silica from siliceous plant matter, and more particularly to methods for producing porous amorphous biogenic silica from rice hulls and other siliceous biogenic sources by integrated control of thermal treatment and oxidative processing parameters. Still more particularly, the present invention relates to a control architecture for controlling the properties of biogenic silica, in which: (a) calcination temperature serves as the primary independent variable controlling surface-area evolution and determining a temperature-history-dependent surface-area plateau; (b) peroxide-mediated oxidative intensity serves as a secondary control variable influencing carbon-pathway partitioning between in-situ combustion and oxidative depolymerization of organic carbon away from silica structures; and (c) substantially complete removal of non-siliceous inorganic flux constituents is maintained as a prerequisite safety constraint to prevent sintering, crystallization, and uncontrolled pore collapse during calcination.

### BACKGROUND OF THE INVENTION

### Description of the Related Art

Amorphous silica derived from biogenic sources—including rice hulls (Oryza sativa), rice straw, wheat chaff, sugar cane bagasse, corn cobs, and other siliceous plant materials—has attracted considerable attention as a sustainable alternative to synthetic silica produced by precipitation or fuming processes. Biogenic plant matter, and rice hulls in particular, contains silica in an amorphous, lattice-like structure that is intimately interlaced with organic compounds including cellulose, hemicellulose, and lignin, as well as non-siliceous inorganic matter comprising compounds and elements of potassium, sodium, calcium, magnesium, manganese, iron, aluminum, phosphorus, boron, titanium, zinc, and other species. In rice hulls, the amorphous silica content typically ranges from about 15% to about 25% by weight on a dry basis, with the non-siliceous inorganic matter constituting approximately 2% to about 5% by weight.

Various methods have been developed for recovering amorphous silica from biogenic sources. U.S. Pat. No. 6,406,678 to Shipley, U.S. Pat. No. 7,270,794 to Shipley, and U.S. Pat. No. 8,057,771 to Shipley (hereinafter collectively “the Shipley patents”) disclose processes for recovery of amorphous silica from biogenic sources, including methods involving acid treatment and heat treatment of rice hulls to produce amorphous silica with controlled properties. The Shipley patents are incorporated herein by reference in their entireties.

U.S. Patent No. 11,618,684 and its continuation application published as U.S. 2023/0227318 A1, both assigned to KILT, LLC (hereinafter collectively “the KILT patents”), disclose methods for treating siliceous plant matter with chelating agents and acid solutions to manipulate the levels of non-siliceous inorganic matter (also referred to herein as “flux” or “flux constituents”) prior to heat treatment, followed by controlled calcination to produce amorphous biogenic silica with selected surface area, pore volume, and pore diameter characteristics, without requiring any specific pore size peak. The KILT patents teach that varying the amount of non-siliceous inorganic matter remaining in the plant matter and varying the heat treatment temperature can together control the surface area, pore volume, and pore diameter of the resulting silica product.

Additional art in the field of biogenic silica production has generally recognized that the properties of the resulting silica are influenced by both the mineral content of the starting material and the conditions of the thermal treatment. Various researchers have investigated the effects of acid leaching, alkali extraction, and other pre-treatments on the purity and properties of biogenic silica derived from rice hulls and other agricultural residues.

### Limitations of the Related Art

Despite the advances described in the art, the present inventor has recognized several limitations in the art's understanding and teaching of the control of biogenic silica properties, which limitations the present invention addresses.

First, the related art, including the KILT patents, treated the flux content (i.e., the level of non-siliceous inorganic matter remaining in the plant matter prior to calcination) as a continuously tunable variable that, together with calcination temperature, could be adjusted along a continuum to control the surface area of the resulting silica. This treatment conflated two functionally distinct roles: (i) the role of flux removal as a safety prerequisite ensuring that the silica lattice is not compromised during calcination, and (ii) the role of calcination temperature as the parameter that governs the surface-area evolution of the silica. The present inventor has recognized that once the flux is reduced below a critical threshold—i.e., once the non-siliceous inorganic matter is substantially completely removed—further manipulation of flux content contributes negligibly to surface-area control. Below this threshold, it is the calcination temperature and the complete thermal history that govern the surface-area plateau achieved by the silica product. The temperature history dependent surface area plateau is independent of peroxide intensity once flux removal is complete.

Second, the references did not disclose or recognize the mechanism of carbon pathway partitioning during primary combustion of the plant matter—that is, how the oxidative treatment applied to the plant matter (particularly the intensity of peroxide-mediated oxidation) determines the proportion of carbon that remains associated with silica structures at the molecular level wherein combustion takes place immediately adjacent to the silica structures—with attendant risk of localized overheating at molecular level carbon-silica interfaces and the carbon proportion that is oxidatively volatilized away from silica structures by radiant heat - forming a vapor envelope around the plant matter/silica particle – and is combusted at the vaporized carbon envelope interface with furnace combustion gases containing excess oxygen. The present invention recognizes and teaches that peroxide intensity actively governs the relative partitioning, and that carbon-pathway partitioning is a controllable process parameter, not merely an observed natural phenomenon between these two carbon-removal pathways, with significant consequences for the residual carbon content, the structural integrity of the silica, and the properties of the final product.

Third, the art did not disclose or recognize that the surface area of biogenic silica produced by calcination evolves through discrete temperature-history-dependent plateaus rather than following a smooth, continuous function of calcination temperature. The present inventor has discovered that the BET surface area of the resulting silica, in the range of about 200 m²/g to about 500 m²/g, assumes plateau values that are a function of the complete thermal history experienced by the material—including ramp rate, peak temperature, hold time, atmosphere composition, and material packing density, independent of furnace geometry—and not solely of the final calcination temperature.

Fourth, the identified references did not disclose or recognize the expanded dispersibility continuum exhibited by the biogenic silica produced by the methods of the present invention, including the phenomenon of in-compound breakup, whereby silica particles undergo further dispersion and size reduction when incorporated into a matrix material (such as a rubber compound, polymer melt, or coating formulation) during mechanical mixing operations. This in-compound breakup is a consequence of the hierarchically porous microstructure preserved by the safety constrained flux removal and controlled calcination taught herein, and not dependent on peroxide intensity.

### SUMMARY OF THE INVENTION

The present invention provides a method for producing porous amorphous biogenic silica with controlled surface area in the range of about 200 m²/g to about 500 m²/g from siliceous plant matter, such as rice hulls, through an integrated, hierarchical three-element control architecture that overcomes the limitations of the identified art.

In accordance with the present invention, the three-element control architecture comprises:
(1) Calcination temperature as the primary independent control variable. The calcination temperature, together with the complete thermal history (including ramp rate, peak temperature, hold time, and atmosphere), determines the surface-area plateau of the resulting silica. The present invention teaches that the BET surface area of the silica product assumes discrete, temperature-history-dependent plateau values, which are not predictable from final calcination temperature alone and cannot be interpolated or extrapolated from continuous models taught in the existing art, in the range of about 200 m²/g to about 500 m²/g, and that the operator selects the target surface-area plateau by selecting the appropriate thermal profile, not by adjusting flux content.
(2) Peroxide-mediated oxidative intensity as a secondary control variable. The intensity of peroxide-mediated oxidative treatment applied to the flux-removed plant matter prior to the onsite of calcination temperatures governs the carbon-pathway partitioning only and does not control the surface-area plateau, which is determined solely by the temperature history. Higher peroxide intensity shifts the partition toward oxidative depolymerization by reducing the molecular weight of carbon compounds so they volatilize away from silica at temperatures below the calcination temperature, thereby avoiding localized overheating at carbon-silica interfaces and preserving the native pore structure of the silica. Lower peroxide intensity leaves more carbon to be removed by in-situ combustion during calcination, which risks localized overheating at carbon-silica interfaces and potential structural damage to the adjacent silica.
(3) Substantially complete removal of non-siliceous inorganic flux constituents as a safety constraint. The substantially complete removal of non-siliceous inorganic flux constituents—including alkali metals, alkaline earth metals, and transition metals—is maintained as a prerequisite safety constraint prior to calcination. This removal prevents flux-induced sintering of the silica lattice, catalytic crystallization (e.g., formation of cristobalite or tridymite), uncontrolled pore collapse, and entrapment of impurities within sintered structures during calcination. Once flux is reduced below the critical threshold, flux removal no longer functions as a surface area control variable, further reduction does not materially change the achievable surface area; the surface area is governed by the calcination temperature and thermal history.

The biogenic silica produced by the method of the present invention further exhibits an expanded dispersibility continuum, including the phenomenon of in-compound breakup, wherein as-produced silica particles undergo further dispersion and size reduction during downstream incorporation into matrix materials under mechanical shear. This dispersibility continuum extends from as-produced particles through dry-milled and wet-dispersed states to in-compound dispersed particles, with each successive stage potentially achieving finer dispersion than the preceding stage.

The present invention also provides porous amorphous biogenic silica products produced by the methods described herein, which products are characterized by BET surface area in the range of about 200 m²/g to about 500 m²/g, amorphous crystal structure, controlled residual carbon content, and the ability to undergo in-compound breakup during mechanical incorporation into a matrix material.

Further features, aspects, objects, advantages, and possible applications of the present invention will become apparent from a study of the exemplary embodiments and examples described below, in combination with the figures, and the appended claims.

### DESCRIPTION OF THE DRAWINGS

The above and other objects, aspects, features, advantages, and possible applications of the present invention will be more apparent from the following more particular description thereof, presented in conjunction with the following drawings. It should be understood that like reference numbers used in the drawings may identify like components.

FIG. 1 is a schematic illustration of exemplary silica structures, demonstrating the effect of flux agent concentration and surface area on combustion temperature and dispersibility.

### DETAILED DESCRIPTION

The present invention will now be described in detail with reference to specific embodiments thereof, it being understood that these embodiments are provided by way of illustration and not limitation, and that the scope of the invention is defined by the appended claims.

Unless defined otherwise, all technical and scientific terms used herein have the same meaning as commonly understood by one of ordinary skill in the art to which the subject matter disclosed herein belongs. Although any methods, devices, and materials similar or equivalent to those described herein can be used in the practice or testing of the presently disclosed subject matter, representative methods, devices, and materials are described herein.

All references to singular characteristics or limitations of the present disclosure shall include the corresponding plural characteristic(s) or limitation(s) and vice versa, unless otherwise specified or clearly implied to the contrary by the context in which the reference is made.

As used herein (when used in this application, including the claims), the terms “a,” “an,” and “the” refer to “one or more.” The use of the word “a” or “an” when used in conjunction with the term “comprising” in the claims and/or the specification may mean “one,” but it is also consistent with the meaning of “one or more,” “at least one,” and “one or more than one.”

As used herein, the term “about” means ± 2% of the recited value. As used herein, ranges can be expressed as from “about” one particular value to “about” another particular value. It is understood that there are a number of values disclosed herein, and that each value is also herein disclosed as “about” that particular value in addition to the value itself. For example, if the value “5” is disclosed, then “about 5” is also disclosed. It is also understood that each unit between two particular units are also disclosed. For example, if 5 and 10 are disclosed, then 6, 7, 8, and 9 are also disclosed.

### Definitions

As used herein, the term “siliceous plant matter” refers to plant-derived biomass containing amorphous biogenic silica as a natural constituent. Siliceous plant matter includes, without limitation, rice hulls (Oryza sativa), rice straw, wheat chaff, barley husks, sugar cane bagasse, corn cobs, bamboo leaves, and other plant materials in which amorphous silica has been deposited within the plant cell walls during growth.

As used herein, the term “non-siliceous inorganic matter” (also referred to herein as “flux,” “flux constituents,” or “inorganic flux”) refers to inorganic compounds and elements present in the siliceous plant matter other than silicon dioxide (SiO₂). These terms may be used interchangeably herein. Non-siliceous inorganic matter includes, without limitation, compounds and elements of potassium (K), sodium (Na), calcium (Ca), magnesium (Mg), manganese (Mn), iron (Fe), aluminum (Al), phosphorus (P), boron (B), titanium (Ti), zinc (Zn), and other metallic and semi-metallic species. The term “flux” is used because these constituents function analogously to fluxing agents in ceramics: they lower the effective sintering temperature of the silica, promote crystallization, and can cause uncontrolled densification and pore collapse during calcination if not removed.

As used herein, the term “calcination” refers to the heat treatment of siliceous plant matter in the presence of an oxygen-containing atmosphere (typically air) at elevated temperatures sufficient to combust or oxidize substantially all of the organic constituents (cellulose, hemicellulose, lignin, and their degradation products) while preserving the amorphous structure of the biogenic silica. Calcination temperatures employed in the present invention range from about 400°C to about 800°C.

As used herein, “surface area” refers to the specific surface area of the silica product as measured by the Brunauer-Emmett-Teller (BET) nitrogen adsorption method in accordance with ASTM D1993 or ISO 9277, or equivalent standardized procedures. Surface area values reported herein are BET surface area values unless otherwise specified.

As used herein, “substantially complete removal” of non-siliceous inorganic matter (or "substantially completely removing" non-siliceous inorganic flux constituents) means reduction of the total non-siliceous inorganic matter content to below about 1,000 parts per million (ppm) by weight of the dried treated plant matter prior to calcination. In some embodiments, substantially complete removal reduces the total non-siliceous inorganic matter to below about 500 ppm by weight. In other embodiments, substantially complete removal reduces the total non-siliceous inorganic matter to below about 300 ppm by weight. The measurement of non-siliceous inorganic matter content may be performed by inductively coupled plasma optical emission spectrometry (ICP-OES), X-ray fluorescence (XRF), or other suitable analytical techniques.

As used herein, “peroxide-mediated oxidative treatment” (or “oxidative treatment”) refers to the treatment of siliceous plant matter with an aqueous solution containing one or more peroxide compounds, including without limitation hydrogen peroxide (H₂O₂), sodium peroxide (Na₂O₂), calcium peroxide (CaO₂), peracetic acid (CH₃CO₃H), and combinations thereof. The treatment effects partial oxidation of organic constituents and deposits oxidative species on and within the plant matter matrix. The peroxide species listed herein are exemplary and not limiting; any peroxide capable of oxidative depolymerization at sub calcination temperatures may be used.

As used herein, “carbon pathway partitioning” refers to the division of residual organic carbon removal pathways between at least two distinguishable pathways: (i) in-situ combustion (also referred to as bulk thermal oxidation), in which carbon compounds that remain intimately associated with silica structures after oxidative treatment combust during calcination when the calcination temperature exceeds their ignition point in the prevailing atmosphere, with attendant risk of localized overheating at carbon-silica interfaces; and (ii) oxidative depolymerization, in which peroxide-mediated oxidative treatment reduces the molecular weight of organic carbon compounds (cellulose, hemicellulose, lignin, and their degradation products) by cleaving polymer chains into lower-molecular-weight fragments that volatilize away from silica structures before calcination temperatures are reached, thereby removing carbon from the molecular proximity of the silica before it can burn and avoiding localized overheating.

As used herein, “localized overheating” (also referred to as “hot spots”) refers to temperature excursions at the micro-scale or meso-scale within the calcining plant matter that exceed the nominal bulk calcination temperature, caused by exothermic combustion of residual organic carbon that remains intimately associated with silica structures when insufficient peroxide treatment has been applied to oxidatively volatilized that carbon. Localized overheating is an adverse consequence of insufficient oxidative depolymerization and can cause localized pore collapse, sintering, or densification of the adjacent silica. The peroxide-mediated oxidative treatment of the present invention is employed to reduce or avoid localized overheating by oxidatively volatilizing carbon away from silica structures before calcination combustion temperatures are reached.

As used herein, “temperature-history-dependent plateau” refers to the observation that the BET surface area of the resulting silica, within the range of about 200 m²/g to about 500 m²/g, assumes discrete plateau values that are determined not solely by the final calcination temperature but by the complete thermal history experienced by the material, including ramp rate, peak temperature, hold time, atmosphere composition, air flow rate, and the mass and packing density of the material in the calcination vessel.

As used herein, “dispersibility continuum” refers to the range of dispersion states achievable by the biogenic silica product, extending from as-produced particles through dry-milled particles, wet-dispersed particles, and in-compound dispersed particles.

As used herein, “in-compound breakup” refers to the phenomenon whereby biogenic silica particles undergo further dispersion and size reduction when incorporated into a matrix material and subjected to mechanical mixing, wherein the breakup occurs within the compound matrix and is driven by the shear and compressive forces of the mixing process acting on the hierarchically porous silica structure. In-compound breakup is distinguished from conventional milling or grinding in that the breakup occurs in situ during compound formation rather than as a separate upstream comminution step.

As used herein, “peroxide intensity” refers to a composite parameter reflecting the combined effect of peroxide concentration, treatment temperature (below the decomposition temperature of the peroxide species), and treatment duration on the degree of oxidative treatment. Higher peroxide intensity corresponds to higher peroxide concentrations, higher treatment temperatures, longer treatment durations, or combinations thereof.

### Staring Material

In accordance with the present invention, the starting material is siliceous plant matter containing amorphous biogenic silica. In some embodiments, the siliceous plant matter comprises rice hulls (Oryza sativa). Rice hulls typically contain about 15% to about 25% by weight amorphous silica on a dry basis, along with cellulose (about 25-35%), hemicellulose (about 15-25%), lignin (about 15-25%), and typically about 2% to about 5% by weight non-siliceous inorganic matter.

The biogenic silica in rice hulls exists in a natural lattice-like structure within the plant cell walls. The silica is deposited during the growth of the rice plant as the plant takes up monosilicic acid (Si(OH)₄) from the soil solution and deposits it as amorphous hydrated silica (SiO₂·nH₂O) within the cell walls, cell lumens, and intercellular spaces of the hull. This deposition produces a three-dimensional amorphous silica framework that is intimately interlaced with the organic structural components of the plant cell wall, creating a composite structure in which the silica and organic phases are interpenetrated at the nanometer to micrometer scale.

The non-siliceous inorganic matter in rice hulls is distributed throughout the hull structure, with potassium typically being the most abundant non-siliceous inorganic element, followed by calcium, magnesium, phosphorus, and iron, with lesser amounts of sodium, manganese, aluminum, boron, titanium, zinc, and other trace elements. These non-siliceous inorganic constituents are present as ionic species within the plant tissue, as co-precipitated phases within the silica lattice, and as discrete mineral inclusions.

In other embodiments, the siliceous plant matter may comprise rice straw, wheat chaff, barley husks, oat hulls, sugar cane bagasse, bamboo leaves, corn cobs, or other plant materials containing biogenic silica. The principles and methods of the present invention are applicable to any siliceous plant matter containing biogenic amorphous silica and non-siliceous inorganic matter, although the specific process parameters (e.g., chelation conditions, peroxide intensity, calcination temperature) may be adjusted depending on the composition and structure of the particular plant matter employed. The control architecture described herein applies to any siliceous plant matter containing biogenic amorphous silica, regardless of species specific composition.

### Flux Removal – The Safety Constraint

The first step of the method of the present invention comprises treating the siliceous plant matter to substantially completely remove non-siliceous inorganic flux constituents. In accordance with the control architecture of the present invention, this flux removal step is framed and maintained as a safety constraint—a prerequisite condition that must be satisfied before calcination—rather than as a tunable process variable for controlling the surface area of the resulting silica.

The purpose of substantially complete flux removal is to prevent the following deleterious effects during calcination: (i) flux-induced sintering of the amorphous silica lattice, whereby the presence of alkali metals (particularly potassium and sodium) and alkaline earth metals (particularly calcium and magnesium) lowers the effective sintering temperature of the silica, causing premature densification, pore closure, and loss of surface area at calcination temperatures that would otherwise preserve the porous structure; (ii) catalytic crystallization, whereby flux constituents catalyze the conversion of amorphous silica to crystalline phases such as cristobalite or tridymite at calcination temperatures, resulting in loss of amorphous character and associated loss of surface area and reactivity; (iii) uncontrolled pore collapse, whereby localized high concentrations of flux constituents cause non-uniform sintering and random pore closure, resulting in unpredictable and non-reproducible silica properties; and (iv) entrapment of impurities within the sintered structure, whereby flux constituents become permanently incorporated into the densified silica matrix and cannot be removed by subsequent washing.

The flux removal may be accomplished by one or more of the following treatments, or combinations thereof:
(a) Chelation treatment: The siliceous plant matter is soaked in an aqueous solution containing one or more chelating agents selected from the group consisting of citric acid, ethylenediaminetetraacetic acid (EDTA), acetic acid, ethylenediamine, dimercaptosuccinic acid (DMSA), nitrilotriacetic acid (NTA), alpha-lipoic acid, diethylenetriaminepentaacetic acid (DTPA), and combinations thereof. The chelating agents complex with the non-siliceous inorganic ions, rendering them soluble and removable from the plant matter matrix. Chelating agent amounts range from about 0.001 kg to about 1 kg per kg of dry plant matter, such as from about 0.01 kg to about 0.1 kg per kg of dry plant matter. The chelation treatment is typically conducted at temperatures from about 20°C to about 100°C for durations of about 30 minutes to about 24 hours. The chelating agents listed herein are exemplary; any agent capable of complexing non siliceous inorganic ions may be used.
(b) Acid treatment: The siliceous plant matter is treated with an aqueous solution of one or more mineral acids selected from the group consisting of sulfuric acid, nitric acid, hydrochloric acid, phosphoric acid, and combinations thereof. Acid concentrations range from about 0.1% to about 20% by weight. The acid treatment dissolves and removes non-siliceous inorganic constituents from the plant matter matrix. Treatment durations range from about 30 minutes to about 12 hours at temperatures from about 20°C to about 100°C.
(c) Combined treatment: In certain embodiments, the siliceous plant matter is subjected to both chelation treatment and acid treatment, either sequentially or simultaneously, to achieve enhanced flux removal. For example, the plant matter may be first treated with a chelating agent solution (e.g., 5% citric acid) followed by rinsing and then treatment with a dilute mineral acid (e.g., 2% HCl), or vice versa.

Following the flux removal treatment(s), the treated plant matter is typically rinsed with water (such as deionized or distilled water) to remove residual treatment chemicals and dissolved inorganic species, and then dried. The drying may be performed at temperatures from about 60°C to about 150°C.

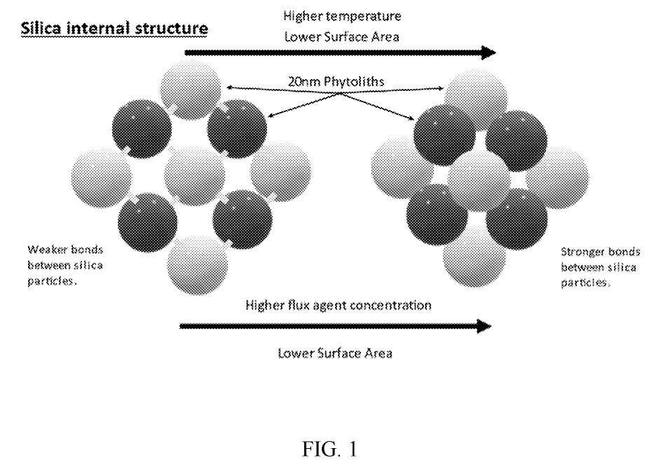

A key insight of the present invention is the reframing of flux removal from a tunable variable to a safety constraint. In the related art, including the KILT patents, it was taught that the operator could adjust the flux level and the calcination temperature in concert to target a desired surface area. FIG. 1 illustrates exemplary silica structures demonstrating the effect of flux agent concentration and surface area on combustion temperature, highlighting the inverse relationship between flux content and silica surface area, as well as the microstructural changes with varying heat treatment conditions.

The present inventor has recognized that this teaching, while functional, obscured the true control architecture. Once the flux is reduced below the critical threshold for substantially complete removal (i.e., below about 1,000 ppm total non-siliceous inorganic matter, such as below about 500 ppm, or below about 300 ppm), further reduction in flux content does not materially change the surface area achievable at a given calcination temperature. The surface area is now governed by the calcination temperature and the complete thermal history. The practical consequence is that the operator need not precisely titrate flux levels to achieve a surface-area target; instead, the operator ensures that flux is substantially completely removed (satisfying the safety constraint) and then uses the calcination thermal profile as the primary control variable to select the target surface-area plateau.

### Carbon Pathway Partitioning

During calcination in the presence of oxygen, the organic constituents of the treated plant matter—including cellulose, hemicellulose, lignin, and their degradation products—must be removed by oxidation to yield the porous amorphous silica product. The present invention recognizes that the removal of residual organic matter (carbon) proceeds through at least two distinguishable pathways, and that the relative contribution of each pathway (the "carbon pathway partition") is controllable by the peroxide-mediated oxidative treatment applied before or during calcination.

Pathway 1: Bulk thermal oxidation. In bulk thermal oxidation, carbon compounds throughout the treated plant matter combust homogeneously when the calcination temperature exceeds their respective ignition points in the prevailing oxygen-containing atmosphere. This pathway is primarily governed by the calcination temperature, the oxygen concentration, and the air flow rate. Bulk thermal oxidation proceeds from the exterior surfaces of the plant matter particles inward, and the rate and completeness of carbon removal by this pathway depend on the temperature, time at temperature, and mass transfer of oxygen to the interior of the particles. Bulk thermal oxidation is a relatively homogeneous process that does not preferentially create localized temperature excursions.

Pathway 2: Oxidative Depolymerization Pathway. During primary calcination, peroxide-mediated oxidative treatment reduces the molecular weight of organic carbon compounds within the treated plant matter by cleaving cellulose, hemicellulose, lignin, and their degradation products into lower-molecular-weight fragments. These lower-molecular-weight fragments have lower boiling and sublimation points than the original high-molecular-weight polymers and accordingly volatilize away from the silica structures at temperatures below the calcination combustion temperature. This volatilization occurs during primary calcination, prior to the onset of oxygen combustion, and results in the formation of a vapor envelope around each plant matter particle, effectively preventing oxygen from directly contacting the residual carbon associated with silica structures. As a consequence, oxygen cannot immediately burn the intermixed carbon at the molecular level, thereby avoiding localized overheating and hot spots. The extent of molecular weight reduction and carbon removal via oxidative depolymerization increases with higher peroxide intensity, which helps preserve the native pore structure of the silica by reducing the amount of residual carbon available for in-situ combustion.

The control architecture is independent of furnace geometry and applies to any entrained flow oxidation reactor or equivalent thermal oxidative environment.

The relative contribution of each pathway to the total carbon removal—the carbon pathway partition—is controlled by the peroxide intensity of the oxidative treatment applied to the treated plant matter. This relationship is described in greater detail in the following paragraphs.

### Peroxide-Mediated Oxidative Treatment – The Secondary Control Variable

In accordance with the present invention, the treated (flux-removed) siliceous plant matter is contacted with an aqueous solution containing a peroxide compound to effect partial oxidation of organic matter and to deposit peroxide residues that will influence the carbon pathway partition during subsequent calcination. The peroxide-mediated oxidative treatment is the secondary control variable in the three-element control architecture of the present invention.

The peroxide compound can be hydrogen peroxide (H₂O₂). In alternative embodiments, the peroxide compound may be selected from the group consisting of sodium peroxide (Na₂O₂), calcium peroxide (CaO₂), peracetic acid (CH₃CO₃H), potassium peroxide, magnesium peroxide, urea hydrogen peroxide, and combinations thereof. When sodium peroxide or calcium peroxide is used, appropriate measures should be taken to ensure that the metal cation introduced by the peroxide compound does not contribute to the flux content above the threshold for substantially complete removal; this may be accomplished by post-treatment rinsing.

The peroxide treatment parameters include:

Peroxide concentration: From about 0.1% to about 30% by weight of the aqueous treatment solution. In some embodiments, the peroxide concentration is from about 1% to about 10% by weight. In other embodiments, the peroxide concentration is from about 3% to about 8% by weight.

Treatment temperature: From about 20°C to about 95°C. In some embodiments, the treatment temperature is from about 40°C to about 80°C. Higher treatment temperatures increase the rate of peroxide decomposition and the degree of oxidative attack on the organic constituents.

Treatment duration: From about 10 minutes to about 24 hours. In some embodiments, the treatment duration is from about 1 hour to about 6 hours.

As used herein, “peroxide intensity” is a composite parameter reflecting the combined influence of peroxide concentration, treatment temperature, and treatment duration on the extent and nature of the oxidative treatment. Higher peroxide intensity is achieved by increasing any one or more of these parameters. The peroxide intensity controls the following aspects of the process:

Degree of pre-oxidation of organic matter: Higher peroxide intensity results in greater extent of oxidation of the cellulose, hemicellulose, and lignin in the treated plant matter prior to calcination, reducing the total organic carbon content entering the calcination step and changing the chemical nature of the remaining organic residues.

Degree of carbon molecular weight reduction: Higher peroxide intensity results in more extensive cleavage of organic polymer chains within the plant matter, reducing the molecular weight of carbon compounds so that a greater proportion volatilizes away from silica structures at temperatures below the calcination combustion temperature.

Carbon pathway partition: Higher peroxide intensity shifts the carbon pathway partition toward oxidative depolymerization, removing carbon from the proximity of silica before combustion and thereby avoiding localized overheating at carbon-silica interfaces. Lower peroxide intensity shifts the partition toward in-situ combustion, in which carbon burns during calcination while still intimately associated with silica structures, risking localized overheating.

The practical consequence of the carbon pathway partitioning control is as follows: When higher peroxide intensity is employed, a greater proportion of organic carbon is oxidatively volatilized away from silica structures before calcination combustion temperatures are reached, thereby reducing the amount of carbon available for in-situ combustion and avoiding localized overheating at carbon-silica interfaces. This preserves the native pore structure of the silica while achieving lower residual carbon content at a given bulk calcination temperature. Conversely, when lower peroxide intensity is employed, more carbon remains to be removed by in-situ combustion during calcination, which risks localized overheating at carbon-silica interfaces that may cause localized pore collapse, sintering, or a shift in the pore size distribution toward larger pores. Lower peroxide intensity may therefore require lower calcination temperatures or shorter hold times to avoid excessive structural damage from hot spots, potentially at the cost of higher residual carbon content.

In certain embodiments, the peroxide-mediated oxidative treatment is omitted entirely, and carbon removal during calcination can proceed by the bulk thermal oxidation pathway. Some portion of the carbon may already be volatile due to natural processes, or due to prior processing steps, and the use of peroxide shifts the degree of residual carbon removal. In such embodiments, the process of the present invention comprises a two-element control architecture (flux removal as safety constraint; calcination temperature as primary control variable), and the peroxide intensity variable is set to zero. Such embodiments remain within the scope of the present invention.

### Calcination – The Primary Control Variable

In accordance with the present invention, calcination is performed by heat treatment of the treated (and optionally peroxide-treated) plant matter in the presence of an oxygen-containing atmosphere, such as air, at elevated temperatures sufficient to combust the organic constituents and produce porous amorphous biogenic silica. The calcination temperature is the primary control variable in the three-element control architecture of the present invention, determining the surface area of the resulting silica.

Calcination temperatures employed in the present invention range from about 400°C to about 800°C. In some embodiments, the calcination temperature ranges from about 500°C to about 700°C. In other embodiments, the calcination temperature ranges from about 500°C to about 650°C.

Temperature-history-dependent plateaus. The present inventor has discovered that the BET surface area of the resulting biogenic silica does not decrease continuously and smoothly with increasing calcination temperature. Instead, the surface area exhibits discrete plateaus within the range of about 200 m²/g to about 500 m²/g. The specific plateau value achieved at a given nominal calcination temperature depends on the complete thermal history experienced by the material, including the following parameters:

Ramp rate (°C/min) from ambient temperature to the peak calcination temperature. Faster ramp rates may result in different plateau values than slower ramp rates for the same peak temperature, because the rate of temperature increase affects the sequence and kinetics of pore collapse events. However, it should be noted that ramp rate effects are specific to laboratory conditions and may not directly translate to industrial-scale calcination processes.
(i) Peak temperature — the maximum temperature attained during calcination.
(ii) Hold time at peak temperature. Longer hold times allow the system to approach thermal equilibrium at the peak temperature, which may cause the surface area to relax to a lower plateau if the peak temperature is near a plateau transition boundary.
(iii) Atmosphere composition and air flow rate. The oxygen concentration and air flow rate affect the rate of carbon combustion and the local thermal environment within the calcination vessel.
(iv) Mass and packing density of the material in the calcination vessel. Greater mass and higher packing density reduce heat transfer rates, extend thermal gradients within the material bed, and may result in a distribution of thermal histories within a single batch.

For example, in laboratory calcination experiments, material calcined at a nominal peak temperature of 600°C with a rapid ramp rate (e.g., about 20°C/min) may achieve a different surface-area plateau than material calcined at the same nominal peak temperature of 600°C with a slow ramp rate (e.g., about 2°C/min), even when the flux levels and peroxide treatment are identical. This is because the rapid ramp rate may cause the material to pass through certain pore-collapse temperature thresholds too quickly for complete pore collapse to occur at those thresholds, resulting in preservation of some pore populations that would be lost during a slower ramp. However, such ramp rate effects are specific to laboratory conditions and may not directly translate to industrial-scale calcination processes.

The plateau behavior is attributed to the stepwise collapse of different pore-size populations at characteristic temperature thresholds within the biogenic silica structure. Each pore-size population has a distinct thermal stability determined by its local silica wall thickness, wall connectivity, and the degree of hydration or hydroxylation of the pore walls. As the temperature increases through a characteristic threshold, a population of pores with thermal stability at or below that threshold undergoes irreversible collapse (sintering of the pore walls), resulting in a discrete decrease in surface area. Between such thresholds, the surface area remains relatively constant (a plateau). The number, width, and depth of the plateaus depend on the distribution of pore-size populations and their respective thermal stabilities, which are in turn influenced by the botanical source of the silica and the flux removal and peroxide treatment conditions.

In one embodiment, a calcination temperature of about 500°C to about 600°C with a moderate ramp rate of about 5°C/min to about 20°C/min and a hold time of about 1 hour to about 4 hours produces porous amorphous biogenic silica with a BET surface area of about 350 m²/g to about 500 m²/g.

In another embodiment, a calcination temperature of about 600°C to about 700°C with a moderate ramp rate of about 5°C/min to about 15°C/min and a hold time of about 1 hour to about 4 hours produces porous amorphous biogenic silica with a BET surface area of about 300 m²/g to about 400 m²/g.

In yet another embodiment, a calcination temperature of about 500°C to about 550°C with a slow ramp rate of about 1°C/min to about 5°C/min and a hold time of about 2 hours to about 6 hours produces porous amorphous biogenic silica with a BET surface area of about 400 m²/g to about 500 m²/g.

It should be noted that ramp rates are primarily relevant in secondary calcination processes with high residual carbon where temperature control is limited and residual carbon removal is important; during primary calcination, the temperature is controlled at a steady set point.

The invention teaches that the operator selects the target surface-area plateau by selecting the appropriate thermal profile (temperature-time program for the calcination), not by adjusting the flux content. This represents a fundamental departure from existing techniques, in which surface area was understood to be a function of both flux content and calcination temperature.

### Resulting Silica Properties

The porous amorphous biogenic silica produced by the method of the present invention exhibits the following properties:

BET surface area: About 200 m²/g to about 500 m²/g, with the specific value within this range being determined by the calcination thermal profile as described above.

Pore volume: About 0.1 cc/g to about 0.5 cc/g, as measured by nitrogen adsorption (BJH method) or mercury intrusion porosimetry.

Pore diameter: About 20 A0 to about 150 A0 (about 2 nm to about 15 nm), with the pore size distribution determined by the calcination thermal profile and the peroxide intensity.

Crystal structure: Amorphous, as confirmed by X-ray diffraction (XRD) analysis showing no detectable crystalline silica phases (no cristobalite, tridymite, or quartz peaks). The preservation of amorphous character is ensured by the substantially complete removal of flux constituents (the safety constraint) prior to calcination.

Residual carbon content: From about 0.001% to about 5% by weight of the silica product, controllable by selection of the peroxide intensity (secondary control variable) and the calcination thermal profile (primary control variable). In some embodiments, the residual carbon content is from about 0.01% to about 2% by weight.

Non-siliceous inorganic content: Less than about 1,000 ppm by weight, such less than about 500 ppm by weight, or less than about 300 ppm by weight, in the as-produced silica product. The non-siliceous inorganic content may be further reduced by post-calcination washing with deionized water or dilute acid solutions.

### Dispersibility Continuum and In-Compound Breakup

The biogenic silica produced by the method of the present invention exhibits an expanded dispersibility continuum that has not been previously recognized or disclosed in the identified art. The as-produced silica has a particle size typically in the range of about 1 µm to about 500 µm, depending on the starting plant matter particle size and any post-calcination milling applied.

The silica particles are characterized by a hierarchical porous structure that is a direct consequence of the biogenic origin of the silica and the preservation of the native pore architecture by the substantially complete flux removal and controlled calcination of the present invention. This hierarchical structure includes porosity at multiple length scales: nanometer-scale pores within the silica walls (contributing to the high BET surface area), micrometer-scale pores corresponding to the original plant cell lumens, and mesoscale structural features corresponding to the original cell wall architecture.

The hierarchical porous structure creates internal fracture planes along pore walls and at interfaces between structural domains of different density or connectivity. When the silica is subjected to mechanical stress, these fracture planes serve as preferential breakage sites, enabling progressive size reduction without the generation of dense, non-porous fragments.

In-compound breakup. When the biogenic silica produced by the method of the present invention is incorporated into a matrix material—including, without limitation, a rubber compound, a polymer melt, a paint or coating formulation, an adhesive, a sealant, a cosmetic formulation, or any other formulated product—and subjected to mechanical mixing operations including, without limitation, mixing in a Banbury mixer, an internal mixer, a two-roll mill, a single-screw or twin-screw extruder, a high-shear mixer, a bead mill, or a ball mill, the silica particles undergo further dispersion and size reduction during the mixing process itself. This in-compound breakup is distinguished from conventional pre-mixing comminution (dry milling, jet milling, wet grinding) in that the breakup occurs within the compound matrix, driven by the shear forces, compressive forces, and elongational forces generated during mechanical mixing acting on the hierarchically porous silica structure.

The dispersibility continuum thus extends through the following stages, with each successive stage potentially achieving finer dispersion than the preceding stage:
1. A process for producing porous amorphous biogenic silica from treated rice hulls, comprising: (a) subjecting rice hulls to an aqueous oxidative treatment effective to remove non-siliceous inorganic flux constituents such that the treated rice hulls satisfy a flux-removal safety constraint before combustion; (b) introducing the treated rice hulls into an entrained-flow oxidation reactor operated under substantial excess air, wherein reactor temperature is controlled by excess-air flow rather than by oxygen limitation; (c) oxidatively burning the treated rice hulls in the reactor under said substantial excess air for a furnace residence time selected to leave residual carbon in a reactor-produced silica ash; and (d) subjecting the reactor-produced silica ash to secondary calcination in an oxygen-containing atmosphere under a three-element control architecture comprising calcination temperature, oxidative-agent intensity, and thermal residence time, thereby removing at least a portion of the residual carbon and producing porous amorphous biogenic silica, wherein the process excludes carbonization, pyrolysis, oxygen-limited heating, low-oxygen devolatilization, and oxygen-free conditions.
2. The process of item 1, wherein the flux-removal safety constraint comprises reducing the non-siliceous inorganic flux constituents to not more than about 1,000 ppm by weight of dry treated rice hulls, as measured by ICP-OES, XRF, or an equivalent analytical method.
3. The process of item 2, wherein the non-siliceous inorganic flux constituents are reduced to not more than about 500 ppm, not more than about 300 ppm, or not more than about 100 ppm by weight of dry treated rice hulls.
4. The process of item 1, wherein the aqueous oxidative treatment comprises an aqueous peroxide treatment, an aqueous acid treatment, an aqueous chelation treatment, or a combination thereof, provided that flux removal remains a safety constraint and is not used as a tunable variable for selecting a surface-area plateau.
5. The process of item 1, wherein the entrained-flow oxidation reactor is configured to maintain particulate dispersion during oxidative burning and to provide a furnace residence time of from about 0.1 second to about 120 seconds, from about 0.5 second to about 60 seconds, or from about 1 second to about 30 seconds.
6. The process of item 1, wherein the substantial excess air is selected such that combustion in the furnace is oxidative and furnace temperature is governed by excess-air flow while avoiding flux-induced sintering, catalytic crystallization, uncontrolled pore collapse, and crystallization to cristobalite or tridymite.
7. The process of item 1, wherein the oxidative-agent intensity in the secondary calcination is set by oxidant concentration, oxidant partial pressure, oxidant feed rate, or combinations thereof, and corresponds to an oxygen concentration of from about 5 vol% to about 100 vol%, from about 10 vol% to about 60 vol%, or from about 15 vol% to about 30 vol% in the secondary calcination atmosphere.
8. The process of item 1, wherein the thermal residence time of the secondary calcination is from about 1 minute to about 6 hours, from about 5 minutes to about 2 hours, or from about 10 minutes to about 60 minutes.
9. The process of item 1, wherein the secondary calcination produces a silica having a BET surface area of from about 200 m2/g to about 500 m2/g, a residual carbon content of from about 0.001% to about 5% by weight, and preserved amorphous character with mesopore structure retained against uncontrolled pore collapse.
10. A method for selecting a temperature-history-dependent surface-area plateau of porous amorphous biogenic silica produced from treated rice hulls, comprising: (a) operating an entrained-flow oxidation reactor under substantial excess air to burn flux-removed treated rice hulls and form silica ash containing residual carbon; (b) subjecting the silica ash to secondary calcination under an oxygen-containing atmosphere; and (c) selecting a temperature history for the reactor and the secondary calcination such that the silica reaches a temperature-history-dependent BET surface-area plateau, wherein the plateau is governed by a two-factor plateau model comprising bulk reactor temperature and local molecular-level temperature spikes caused by residual carbon burning in intimate contact with silica.
11. The method of item 10, wherein the BET surface-area plateau is within a range of about 200 m2/g to about 500 m2/g.
12. The method of item 11, wherein the BET surface-area plateau is from about 350 m2/g to about 450 m2/g or from about 320 m2/g to about 420 m2/g.
13. The method of item 10, wherein the temperature history is defined by one or more of ramp rate, peak temperature, hold time, air-flow rate, oxidative-agent intensity during secondary calcination, particulate loading, quench rate, and residence time in the entrained-flow oxidation reactor.
14. The method of item 10, wherein the bulk reactor temperature is from about 500°C to about 700°C, from about 500°C to about 650°C, or greater than about 500°C and less than about 600°C.
15. The method of item 14, wherein the bulk furnace temperature is greater than about 500°C and less than about 590°C or greater than about 500°C and less than about 580°C.
16. The method of item 10, wherein the local molecular-level temperature spikes are reduced by lowering residual carbon present in intimate contact with silica before completion of the secondary calcination, thereby maintaining a plateau signature comprising preserved pore volume and avoided abrupt surface-area collapse at a fixed bulk furnace temperature.
17. The method of item 10, wherein the selected plateau is achieved independently of tuning the amount of non-siliceous inorganic flux constituents once the flux-removal safety constraint has been satisfied.
18. A method for controlling carbon-pathway partitioning during production of porous amorphous biogenic silica from treated rice hulls, comprising: (a) burning flux-removed treated rice hulls in an entrained-flow oxidation reactor under substantial excess air to form silica ash containing residual carbon; and (b) performing secondary calcination of the silica ash in an oxygen-containing atmosphere while controlling thermal residence time, wherein carbon-pathway partitioning is controlled between an oxidative depolymerization pathway and in-situ combustion, and wherein increasing oxidative-agent intensity or thermal residence time shifts carbon removal toward oxidative depolymerization and away from in-situ combustion in intimate contact with silica.
19. The method of item 18, wherein in-situ combustion comprises burning residual carbon while the residual carbon remains in intimate contact with silica, thereby creating local molecular-level temperature spikes that contribute to the two-factor plateau model.
20. The method of item 18, wherein the thermal residence time during secondary calcination is selected from about 1 minute to about 6 hours, from about 5 minutes to about 2 hours, or from about 10 minutes to about 60 minutes.
21. The method of item 18, wherein controlling carbon-pathway partitioning provides a carbon-pathway signature comprising lowered residual carbon content with preserved amorphous character, pore volume, and mesopore structure of the silica.
22. The method of item 18, wherein the resulting silica has a residual carbon content of not more than about 5% by weight, not more than about 2% by weight, or not more than about 1% by weight.
23. A porous amorphous biogenic silica product formed from treated rice hulls, the product having: (a) a BET surface area within a temperature-history-dependent plateau of about 200 m2/g to about 500 m2/g; (b) an amorphous structure; (c) a non-siliceous inorganic flux content satisfying a flux-removal safety constraint; and (d) a dispersibility continuum extending from an as-produced state through a mechanically dispersed state and an in-compound dispersed state, wherein the product exhibits in-compound breakup under compounding shear.
24. The product of item 26, wherein the BET surface area is from about 350 m2/g to about 450 m2/g or from about 320 m2/g to about 420 m2/g.
25. The product of item 26, wherein the non-siliceous inorganic flux content is not more than about 1,000 ppm, not more than about 500 ppm, or not more than about 300 ppm by weight.
26. The product of item 26, wherein the product has a pore volume of from about 0.1 cc/g to about 0.5 cc/g and an average pore diameter of from about 2 nm to about 15 nm.
27. The product of item 26, wherein the product has a residual carbon content of from about 0.001% to about 5% by weight or from about 0.001% to about 2% by weight.
28. The product of item 26, wherein the product comprises primary particles, weakly bound agglomerates, or both, such that the product undergoes further breakup during compounding in a rubber, polymer, coating, adhesive, or sealant matrix.
29. The product of item 26, wherein the product, when compounded into an elastomer under mixing shear, attains a dispersion grade of at least about 70% as measured by ASTM D7723 or an equivalent method.
30. The product of item 26, wherein the product is produced by the process of item 1, the method of item 10, or the method of item 18.
31. A process for producing porous amorphous biogenic silica from treated rice hulls, comprising: (a) subjecting rice hulls to an aqueous oxidative treatment effective to remove non-siliceous inorganic flux constituents such that the treated rice hulls satisfy a flux-removal safety constraint before combustion; (b) introducing the treated rice hulls into an entrained-flow oxidation reactor, the reactor being operated under substantial excess air such that reactor temperature is governed by excess-air flow rather than by oxygen limitation; (c) oxidatively burning the treated rice hulls in the reactor for a reactor residence time sufficient to form a reactor-produced silica ash containing residual carbon; and (d) subjecting the reactor-produced silica ash to secondary calcination in an oxygen-containing atmosphere under a three-element control architecture comprising calcination temperature, oxidative-agent intensity, and thermal residence time, thereby removing at least a portion of the residual carbon and producing porous amorphous biogenic silica, wherein the process excludes carbonization, pyrolysis, oxygen-limited heating, low-oxygen devolatilization, and oxygen-free conditions.
32. The process of item 31, wherein the reactor residence time is from about 0.05 second to about 120 seconds, from about 0.1 second to about 30 seconds, or from about 0.5 second to about 10 seconds.
33. The process of item 31, wherein the reactor-produced silica ash has a residual-carbon signature comprising a residual carbon content of from about 0.1% to about 25% by weight before the secondary calcination, carbon located on external surfaces, within internal pore volume, or both, and a carbon-derived temperature-spike potential arising from residual carbon burning in intimate contact with silica.
34. The process of item 33, wherein the residual-carbon signature further comprises a carbon-pathway marker selected from a ratio of oxidatively depolymerized carbon products to in-situ combustion products, a ratio of surface carbon to internal carbon, a volatile-carbon ratio, or combinations thereof.
35. The process of item 31, wherein the secondary calcination employs an oxidative agent selected from oxygen, oxygen-enriched air, ozone, nitrogen oxides, chlorine dioxide, plasma-generated oxidants, UV-ozone, steam-assisted oxidation, and combinations thereof, while carbon removal proceeds through carbon-pathway partitioning between an oxidative depolymerization pathway and in-situ combustion. Peroxide compounds are not used as oxidative agents during secondary calcination.
36. The process of item 35, wherein the oxidative-agent intensity is defined by oxidant concentration, oxidant partial pressure, oxidant feed rate, oxidant photon flux, plasma power, steam-to-oxidant ratio, or combinations thereof.
37. The process of item 31, wherein the process is substantially free of catalytic transition-metal species that materially alter carbon-pathway partitioning, including Fe, Cu, Mn, Co, Ni, V, and Cr, whether present as catalytic ash contaminants, catalytic furnace-lining residues, or catalytic process residues.
38. The process of item 37, wherein a combined concentration of said catalytic transition-metal species in the treated rice hulls, reactor-produced silica ash, or resulting silica is not more than about 500 ppm by weight, not more than about 200 ppm by weight, or not more than about 100 ppm by weight.
39. The process of item 31, wherein the secondary calcination is continuous or semi-continuous, monotonic in oxidative-agent intensity over a carbon-removal interval, free of calcine-quench-calcine cycling, and free of alternating oxidative-agent intensities that would oscillate carbon-pathway partitioning.
40. The process of item 31, wherein the secondary calcination further comprises a non-thermal oxidation mode selected from microwave-assisted oxidation, plasma oxidation, radiative oxidation, and UV-ozone oxidation, provided that the process preserves the oxidative depolymerization pathway and carbon-pathway partitioning between oxidative depolymerization and in-situ combustion.
41. A method for selecting a temperature-history-dependent surface-area plateau of porous amorphous biogenic silica produced from treated rice hulls, comprising: (a) operating a reactor under substantial excess air to burn flux-removed treated rice hulls and form silica ash containing residual carbon; (b) subjecting the silica ash to secondary calcination under an oxygen-containing atmosphere; and (c) selecting a reactor and calcination temperature history such that the silica reaches a temperature-history-dependent BET surface-area plateau governed by a two-factor plateau model comprising bulk furnace temperature and local molecular-level temperature spikes caused by residual carbon burning in intimate contact with silica, wherein the plateau is independent of flux content once the flux-removal safety constraint is satisfied.
42. The method of item 41, wherein the temperature history is defined by one or more of ramp rate, peak temperature, hold time, quench rate, particulate loading, furnace residence time, calcination residence time, air-flow rate, and oxidative-agent intensity.
43. The method of item 41, wherein the plateau exhibits reproducibility across batches within ±10%, ±7%, or ±5% BET surface area variation and exhibits plateau clustering within a band of not more than about 50 m2/g, not more than about 30 m2/g, or not more than about 20 m2/g for batches processed under the same temperature-history parameters.
44. The method of item 41, wherein the plateau depends jointly on said temperature history and carbon-pathway partitioning, such that lowering local molecular-level temperature spikes at a fixed bulk furnace temperature preserves pore volume and inhibits abrupt surface-area collapse.
45. A method for controlling carbon-pathway partitioning during production of porous amorphous biogenic silica from treated rice hulls, comprising: (a) burning flux-removed treated rice hulls under substantial excess air to form silica ash containing residual carbon; and (b) performing secondary calcination of the silica ash while controlling oxidative-agent intensity and thermal residence time, wherein carbon-pathway partitioning is controlled between an oxidative depolymerization pathway and in-situ combustion, and wherein the method defines a carbon-pathway signature comprising one or more of an oxidative-depolymerization product profile, an in-situ combustion marker, a volatile-carbon ratio, and a partitioning window relating said signature to the resulting pore structure and BET surface area.
46. The method of item 45, wherein the oxidative-depolymerization product profile comprises one or more oxidized carbon-containing species removed before or during calcination, and the in-situ combustion marker comprises evidence of residual carbon burning in intimate contact with silica sufficient to create local molecular-level temperature spikes.
47. The method of item 45, wherein the partitioning window is selected such that the resulting silica has a residual carbon content of not more than about 5% by weight, a BET surface area of from about 300 m2/g to about 500 m2/g, and mesopore structure preserved against uncontrolled pore collapse.
48. A porous amorphous biogenic silica product formed from treated rice hulls, the product having: (a) a BET surface area within a temperature-history-dependent plateau of about 300 m2/g to about 500 m2/g; (b) an amorphous structure; (c) a non-siliceous inorganic flux content satisfying a flux-removal safety constraint; (d) hierarchical porosity comprising microporosity, mesoporosity, macroporosity, or a combination thereof; and (e) a dispersibility continuum extending from an as-produced state through a mechanically dispersed state and an in-compound dispersed state, wherein the product exhibits in-compound breakup under compounding shear.
49. The product of item 48, wherein the product further has one or more product signatures selected from a pore-size distribution signature, a silanol-density signature, a fractal-dimension signature, a carbon-pathway signature comprising a volatile-carbon ratio or oxidative-depolymerization products, and plateau clustering corresponding to batches processed under the same temperature-history parameters.
50. The product of item 48, wherein the product has a pore volume of from about 0.1 cc/g to about 0.5 cc/g, an average pore diameter of from about 2 nm to about 15 nm, and a residual carbon content of from about 0.01% to about 5% by weight.

(i) As-produced particles: The silica as recovered from the calcination step, with particle sizes typically in the range of about 1 µm to about 500 µm.

(ii) Dry-milled or jet-milled particles: The as-produced silica after mechanical size reduction by dry milling, jet milling, or similar dry comminution processes, with particle sizes typically in the range of about 0.5 µm to about 100 µm.

(iii) Wet-dispersed particles: The silica after dispersion in a liquid medium with or without dispersing aids, with particle sizes typically in the range of about 0.1 µm to about 50 µm.

(iv) In-compound dispersed particles: The silica as dispersed within a matrix material after mechanical mixing, with effective particle sizes potentially in the range of about 0.01 µm to about 20 µm, depending on the mixing conditions, the matrix viscosity, and the shear history.

In one embodiment, porous amorphous biogenic silica having a BET surface area of about 350 m²/g to about 450 m²/g, produced in accordance with the present invention, when compounded into a natural rubber or synthetic rubber matrix in a Banbury mixer under standard tire tread compounding conditions, achieves a dispersion grade as measured by ASTM D7723 (Standard Test Method for Rubber Property—Macro Dispersion of Fillers in Compounds) or equivalent methodology that is comparable to or exceeds the dispersion grade achieved by commercial precipitated silica grades commonly used in tire tread applications (such as grades having a CTAB surface area of about 160 m²/g to about 200 m²/g). This comparable or superior dispersion performance is achieved despite the biogenic silica having an as-produced particle size larger than that of the commercial precipitated silica, demonstrating the contribution of the in-compound breakup mechanism to the overall dispersion performance.

### Process Integration

The following description provides exemplary, integrated process flows in accordance with the present invention. The steps may be performed in the order described or in modified order as would be apparent to one of ordinary skill in the art, and additional steps may be included as appropriate for a particular application.

A process flow in accordance with the present invention comprises the following steps:

Step 1 — Receipt and preparation of raw material: Raw rice hulls are received, optionally cleaned to remove foreign matter (stones, sand, broken rice kernels), and optionally size-reduced by grinding, cutting, or chopping to a desired particle size range.

Step 2 — Flux removal (safety constraint): The rice hulls are treated with a chelating agent solution, a mineral acid solution, or a combination thereof to substantially completely remove non-siliceous inorganic flux constituents to below the threshold level (below about 1,000 ppm, such as below about 500 ppm, or below about 300 ppm total non-siliceous inorganic matter by weight of dried treated plant matter).

Step 3 — Rinsing and drying: The treated rice hulls are rinsed with water to remove residual treatment chemicals and dissolved species, and dried.

Step 4 — Peroxide-mediated oxidative treatment (secondary control, optional): The treated and dried rice hulls are contacted with an aqueous peroxide solution at a selected peroxide intensity to effect partial oxidation of organic matter and to establish conditions for carbon pathway partitioning during subsequent calcination.

Step 5 — Calcination (primary control): The treated (and optionally peroxide-treated) rice hulls are calcined at a selected thermal profile to produce porous amorphous biogenic silica with a BET surface area within the target plateau range. For batch operations, the thermal profile includes a specific ramp rate, peak temperature, hold time, and atmosphere. However, for continuous commercial production, temperature is controlled within a narrow range, and peak temperature is the primary parameter affecting the process, with ramp rate and hold time being less critical.

Step 6 — Cooling: The calcined silica is cooled to ambient temperature, such as in a controlled atmosphere to prevent moisture adsorption.

Step 7 — Optional post-calcination washing: The cooled silica is optionally washed with deionized water or dilute acid to further reduce residual inorganic content or to remove surface contaminants.

Step 8 — Optional milling/classification: The silica is optionally milled (dry or wet), classified (sieving, air classification), or otherwise size-reduced to a target particle size distribution.

Step 9 — Optional in-compound incorporation: The silica is optionally incorporated into a matrix material (rubber, polymer, coating, etc.) under mechanical mixing conditions, wherein the silica undergoes in-compound breakup as described herein.

### Milling and Particle Size Reduction

The porous amorphous biogenic silica produced by the calcination step may optionally be subjected to one or more milling operations to reduce particle size and to liberate individual nanosized primary particles or loosely bound agglomerates thereof from larger calcined structures.

Suitable milling methods include, but are not limited to, ball milling (wet or dry), jet milling (also referred to as fluid energy milling or micronization), hammer milling, pin milling, and combinations thereof.

In one embodiment, ball milling is employed using ceramic milling media having diameters of about 0.1 mm to about 10 mm, at milling speeds of about 100 rpm to about 500 rpm, for milling durations of about 30 minutes to about 48 hours. Wet ball milling may be performed in an aqueous or solvent medium to assist in de-agglomeration and to reduce re-agglomeration of liberated particles.

In another embodiment, jet milling is employed to reduce particle size without the introduction of milling media contamination. Jet milling utilizes high-velocity gas streams (e.g., compressed air or nitrogen) to accelerate particles against one another or against a target surface, achieving particle size reduction through inter-particle and particle-surface collisions. Jet milling is particularly suitable when low contamination levels are required, such as for electronic-grade or pharmaceutical-grade silica applications.

The milling operation may reduce the as-calcined silica from a particle size of about 1 micrometer to about 500 micrometers to a milled particle size of about 0.05 micrometers to about 50 micrometers, as measured by laser diffraction particle size analysis (e.g., per ISO 13320). In certain embodiments, ball milling of the biogenic silica for about 4 to about 24 hours produces a milled silica having a median particle size (d50) of about 1 micrometer to about 20 micrometers.

Importantly, milling represents one stage of the dispersibility continuum described herein. The as-calcined biogenic silica preserves its native hierarchical porosity due to the substantially complete removal of flux constituents prior to calcination, and this porosity provides internal fracture planes that facilitate particle size reduction during milling at lower energy input compared to conventionally produced (flux-sintered) silica. The milled silica retains its capacity for further in-compound breakup when subsequently incorporated into a matrix material under mechanical shear, as described hereinabove.

In one embodiment, ball-milled biogenic silica having a BET surface area of about 280 m²/g to about 450 m²/g and a median particle size (d50) of about 5 micrometers to about 15 micrometers is suitable as a reinforcing filler in elastomer formulations, as described in greater detail below.

### Dispersed Combustion Calcination

In a certain embodiment, calcination is performed in a dispersed combustion furnace or an entrained-flow oxidation reactor, such as a suspension furnace or cyclone furnace, wherein the treated plant matter is introduced into a combustion chamber in a dispersed or suspended state in a flowing gas stream comprising oxygen (e.g., air). In dispersed combustion, individual particles or small clusters of particles are entrained in the gas flow and are individually exposed to the calcination temperature, rather than being calcined as a static or slowly moving bed.

Dispersed combustion offers several advantages for the production of biogenic silica with controlled properties. First, it provides rapid and substantially uniform heat transfer to each particle, minimizing particle-to-particle temperature variation and thereby promoting a more uniform surface-area plateau across the product batch. Second, the short residence time at peak temperature (typically about 1 second to about 60 seconds, depending on furnace configuration) reduces the risk of over-calcination and uncontrolled pore collapse. Third, the rapid quenching of the product upon exiting the combustion zone preserves the pore structure established at the peak temperature, contributing to the reproducibility of the temperature-history-dependent surface-area plateaus described herein.

In another embodiment, calcination may be performed in a rotary kiln, a muffle furnace, a fluidized bed furnace, or a tunnel kiln. The selection of calcination equipment influences the thermal history experienced by the siliceous plant matter, and thus the surface-area plateau achieved, as described in the section on temperature-history-dependent plateaus. Static or slow-moving bed calcination methods (e.g., muffle furnace, tunnel kiln) generally produce broader distributions of thermal histories within a single batch compared to dispersed combustion methods.

### Particle Morphology – Individual Particles and Agglomerates

The biogenic silica produced by the method of the present invention comprises nanosized primary particles having a mean primary particle diameter of about 5 nm to about 100 nm, such as about 10 nm to about 50 nm, or about 15 nm to about 30 nm, as observed by scanning electron microscopy (SEM) or transmission electron microscopy (TEM). These primary particles are remnants of the phytolith matrix originally deposited within the plant cell structure.

The primary particles may exist in one or more of the following morphological states: (i) individual (unbound) nanosized primary particles held together only by van der Waals forces; (ii) loosely bound agglomerates of primary particles, wherein the interparticle bonds are sufficiently weak that the agglomerates are capable of breakup into individual primary particles or smaller agglomerates upon application of mechanical shear (e.g., during milling or during in-compound mixing); or (iii) mixtures of individual primary particles and loosely bound agglomerates.

Loosely bound agglomerates of primary particles that break up into individual primary particles when mixed with elastomers are equally desirable as individual primary particles for reinforcing filler applications, because the in-compound breakup mechanism provides the requisite dispersion during the compounding process itself, as described hereinabove.

The method of the present invention, by maintaining substantially complete removal of flux constituents as a safety constraint prior to calcination, prevents the formation of strongly bonded aggregates (ceramic bonds) between primary particles. Ceramic bonds, once formed at high temperature in the presence of flux, are essentially irreversible and cannot be broken by mechanical shear during milling or compounding. Thus, the flux removal safety constraint is a prerequisite for producing silica having the particle morphology (individual particles and/or loosely bound agglomerates) required for high dispersibility.

### Reinforcing Silica Compositions

In another aspect, the present invention provides reinforcing silica compositions comprising the porous amorphous biogenic silica described herein, either alone or in combination with one or more additional silicas selected from fumed silica, precipitated silica, and mixtures thereof.

In one embodiment, the reinforcing silica composition comprises the biogenic silica as the sole silica component. In another embodiment, the reinforcing silica composition comprises the biogenic silica in combination with fumed silica. In yet another embodiment, the reinforcing silica composition comprises the biogenic silica in combination with precipitated silica. In still another embodiment, the reinforcing silica composition comprises the biogenic silica in combination with both fumed silica and precipitated silica.

In embodiments where the reinforcing silica composition comprises the biogenic silica in combination with at least one additional silica, the biogenic silica may be present in an amount of about 0.01% to about 99.99% by weight of the total reinforcing silica composition, and the at least one additional silica may be present in an amount of about 0.01% to about 99.99% by weight of the total reinforcing silica composition. In a first sub-embodiment, the biogenic silica is present in an amount of about 0.01% to about 50% and the additional silica is present in an amount of about 50% to about 99.99%, providing a composition in which the biogenic silica serves as a supplemental or synergistic component alongside a majority of conventional silica. In a second sub-embodiment, the biogenic silica is present in an amount of about 50% to about 99.99% and the additional silica is present in an amount of about 0.01% to about 50%, providing a composition in which the biogenic silica is the primary reinforcing filler.

Without wishing to be bound by theory, it is believed that the biogenic silica produced by the method of the present invention may interact synergistically with fumed silica and/or precipitated silica in certain elastomer formulations. The synergistic interaction may arise from the difference in particle morphology and surface chemistry between the biogenic silica (nanosized primary particles with high silanol density) and the additional silica, which together may provide a bimodal or multimodal particle size distribution that improves packing efficiency and filler-elastomer interaction within the compound.

The reinforcing silica composition may be prepared by dry blending the biogenic silica with the additional silica, wet blending in an aqueous or solvent medium, or by co-feeding the biogenic silica and additional silica simultaneously into the elastomer during compounding.

In a specific embodiment, the reinforcing silica composition comprises the porous amorphous biogenic silica produced by the method of the present invention in combination with fumed silica. Without wishing to be bound by theory, it is believed that the combination of biogenic silica and fumed silica provides a particularly advantageous pairing for elastomer reinforcement. The biogenic silica, with its high BET surface area (about 200 m²/g to about 500 m²/g), high silanol density, and hierarchical porous structure, contributes reinforcing capability and high filler-polymer interaction. The fumed silica, produced by high-temperature flame hydrolysis and characterized by a branched chain-like aggregate morphology, contributes thixotropic and rheological control properties to the formulation. Together, the bimodal particle morphology—the roughly spherical biogenic primary particles interspersed with the branched fumed silica aggregates—may provide improved packing efficiency, enhanced filler network formation, and superior mechanical properties compared to either silica type used alone at equivalent total loading.

In one embodiment, the reinforcing silica composition comprises about 10 percent to about 90 percent by weight biogenic silica and about 10 percent to about 90 percent by weight fumed silica, based on the total weight of the reinforcing silica composition. In another embodiment, the biogenic silica is present in an amount of about 20 percent to about 80 percent and the fumed silica is present in an amount of about 20 percent to about 80 percent. In silicone rubber formulations, partial replacement of fumed silica with the biogenic silica at replacement levels of about 10 percent to about 50 percent by weight has been observed to maintain or improve tensile strength while reducing the total cost of the reinforcing filler package.

### Elastomer Formulations and Comparative Performance

The biogenic silica and reinforcing silica compositions described herein may be incorporated as reinforcing fillers into elastomer formulations. Suitable elastomers include, but are not limited to, natural rubber (NR), styrene-butadiene rubber (SBR), polybutadiene rubber (BR), ethylene propylene diene monomer rubber (EPDM), nitrile rubber (NBR), chloroprene rubber (CR), silicone rubber (including polydimethylsiloxane-based elastomers, VMQ, and FVMQ), and blends thereof.

In one embodiment, the reinforcing silica is incorporated into a silicone rubber formulation. Silicone rubber formulations are particularly suitable because the high silanol density on the surface of the biogenic silica (preserved by the controlled calcination method described herein) provides strong filler-polymer interaction with the silicone matrix through hydrogen bonding and condensation reactions with silanol groups on the polymer chain.

In another embodiment, the reinforcing silica is incorporated into a tire rubber compound. As used herein, “tire rubber compound” refers to an elastomer formulation suitable for use in a tire component, including but not limited to tread, sidewall, belt, and innerliner compounds. In one embodiment, the biogenic silica replaces a portion of the precipitated silica conventionally used in tire tread compounds (e.g., precipitated silica such as Zeosil 1165MP or equivalent). The biogenic silica may replace about 10% to about 100% by weight of the precipitated silica in the tire tread formulation.

In one embodiment, a tire tread compound comprising the biogenic silica, when mixed in a Banbury mixer or equivalent internal mixer, achieves a dispersion grade of at least about 70% as measured by ASTM D7723 (Standard Test Method for Rubber Property—Macro-Dispersion of Fillers in Compounds) or equivalent test method. In further embodiments, the dispersion grade is at least about 80%, or at least about 90%.

In one embodiment, an elastomer formulation comprising the biogenic silica exhibits greater tensile strength compared to a comparative formulation in which the biogenic silica is replaced with an equal weight of fumed silica or precipitated silica. In another embodiment, an elastomer formulation comprising the biogenic silica exhibits greater elongation at break compared to such a comparative formulation.

### Additional Flux Removal Thresholds and Calcination Temperature Sub-Ranges

In certain embodiments, the substantially complete removal of non-siliceous inorganic matter reduces the total non-siliceous inorganic matter to below about 2,000 ppm by weight of the treated plant matter. In some embodiments, the total non-siliceous inorganic matter is reduced to below about 1,000 ppm, such as below about 500 ppm, below about 300 ppm, or below about 100 ppm by weight of the treated plant matter.

In the context of the mineral acid treatment described hereinabove, suitable mineral acids include sulfuric acid, nitric acid, hydrochloric acid, phosphoric acid, boric acid, perchloric acid, or combinations thereof.

In one embodiment, the calcination temperature is greater than about 500°C and less than about 600°C. In a further embodiment, the calcination temperature is greater than about 500°C and less than about 590°C. In a still further embodiment, the calcination temperature is greater than about 500°C and less than about 580°C.

### EXAMPLES

The following examples are prophetic and are provided to illustrate the principles and practice of the present invention. These examples are not intended to limit the scope of the invention.

Example 1 – High Surface Area Silica with Moderate Carbon Removal

Raw rice hulls (1 kg, dry basis) are soaked in an aqueous solution of 5% by weight citric acid (0.05 kg citric acid per kg of dry rice hulls; ratio of solution to rice hulls about 10:1 by volume) at 60°C for 4 hours with periodic agitation. The treated hulls are rinsed three times with deionized water and drained. The rinsed hulls are then treated with a 5% by weight aqueous hydrogen peroxide solution at 60°C for 2 hours. Following the peroxide treatment, the hulls are drained and dried at 105°C for 12 hours. The dried, treated hulls are placed in a muffle furnace and calcined under the following thermal profile: ramp from ambient temperature to 550°C at a rate of 10°C/min; hold at 550°C for 2 hours; cool to ambient under natural convection. The atmosphere is ambient air with natural draft ventilation.

Expected results: The resulting porous amorphous biogenic silica has a BET surface area of about 400 m²/g, a pore volume of about 0.30 cc/g, a mean pore diameter of about 40 A0, a residual carbon content of about 1.5% by weight, and a total non-siliceous inorganic content of less than about 400 ppm. XRD analysis confirms amorphous structure with no detectable crystalline phases.

### Example 2 – Lower Surface Area Silica with Enhanced Carbon Removal

Raw rice hulls (1 kg, dry basis) are soaked in an aqueous solution of 2% by weight hydrochloric acid (ratio of solution to rice hulls about 8:1 by volume) at 70°C for 2 hours with periodic agitation. The treated hulls are rinsed four times with deionized water and drained. The rinsed hulls are then treated with a 10% by weight aqueous hydrogen peroxide solution at 80°C for 4 hours. Following the peroxide treatment, the hulls are drained and dried at 105°C for 12 hours. The dried, treated hulls are placed in a muffle furnace and calcined under the following thermal profile: ramp from ambient temperature to 650°C at a rate of 5°C/min; hold at 650°C for 3 hours; cool to ambient under natural convection. The atmosphere is ambient air with forced draft ventilation.

Expected results: The resulting porous amorphous biogenic silica has a BET surface area of about 320 m²/g, a pore volume of about 0.22 cc/g, a mean pore diameter of about 55 A0, a residual carbon content of about 0.5% by weight, and a total non-siliceous inorganic content of less than about 300 ppm. XRD analysis confirms amorphous structure with no detectable crystalline phases. The higher peroxide intensity and higher calcination temperature, relative to Example 1, result in lower surface area (a lower plateau), lower residual carbon content, and a shift in the pore size distribution toward larger pores.

### Example 3 – In-Compound Breakup Demonstration

Porous amorphous biogenic silica produced in accordance with Example 1 (BET surface area about 400 m²/g, as-produced particle size about 50 µm to about 200 µm, median particle size about 100 µm) is compounded into a natural rubber matrix. The rubber compound formulation comprises 100 parts by weight natural rubber (SMR 20), 60 parts by weight biogenic silica, 5 parts by weight silane coupling agent (Si69), and other standard compounding ingredients (zinc oxide, stearic acid, processing oil, sulfur, accelerator). The compound is mixed in a laboratory Banbury mixer (1.6 L capacity) at a rotor speed of 60 rpm, a fill factor of 0.70, and a dump temperature of 155°C. The total mixing time is 12 minutes in two stages.

Expected results: The dispersion grade of the biogenic silica in the rubber compound, measured by ASTM D7723, is expected to be at least about 5 on a 1-10 scale, indicating macro-dispersion performance comparable to commercial precipitated silica grades (e.g., Evonik Ultrasil 7000 GR or PPG Hi-Sil EZ 160G). Microscopic examination of thin sections of the cured compound is expected to reveal that the biogenic silica particles have undergone substantial in-compound breakup, with the median dispersed particle size in the compound being significantly smaller (about 5 µm to about 30 µm) than the as-produced particle size (about 50 µm to about 200 µm).

### Comparative Observations

Comparison of Examples 1 and 2 illustrates the operation of the three-element control architecture of the present invention. In both examples, the flux removal step satisfies the safety constraint (total non-siliceous inorganic matter reduced to well below 1,000 ppm). The different surface areas achieved (about 400 m²/g versus about 320 m²/g) are attributable primarily to the different calcination thermal profiles (550°C versus 650°C peak temperature, and different ramp rates), confirming calcination temperature as the primary control variable. The different residual carbon contents (about 1.5% versus about 0.5%) are attributable primarily to the different peroxide intensities (5% H₂O₂ at 60°C for 2 hours versus 10% H₂O₂ at 80°C for 4 hours) and the different calcination temperatures, confirming peroxide intensity as the secondary control variable governing carbon pathway partitioning.

### FURTHER DETAILS OF THE INVENTION

It should be understood that the disclosure of a range of values is a disclosure of every numerical value within that range, including end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the apparatus and methods of using and making the same disclosed herein have been discussed and illustrated, it is to be distinctly understood that the invention is not limited thereto but may be otherwise variously embodied and practiced within the scope of the following claims.

What is claimed is:

1. A process for producing porous amorphous biogenic silica from treated rice hulls, comprising:
(a) subjecting rice hulls to an aqueous oxidative treatment effective to remove non-siliceous inorganic flux constituents such that treated rice hulls satisfy a flux-removal safety constraint before combustion;
(b) introducing the treated rice hulls into an entrained-flow oxidation reactor operated under excess air, wherein reactor temperature is controlled by excess-air flow rather than by oxygen limitation;
(c) oxidatively burning the treated rice hulls in the reactor under said excess air for a reactor residence time selected to leave residual carbon in a reactor-produced silica ash; and
(d) subjecting the reactor-produced silica ash to secondary calcination in an oxygen-containing atmosphere under a three-element control architecture comprising calcination temperature, oxidative-agent intensity, and thermal residence time, thereby removing at least a portion of the residual carbon and producing the porous amorphous biogenic silica.

2. The process of claim 1, wherein the flux-removal safety constraint comprises reducing the non-siliceous inorganic flux constituents to not more than about 1,000 ppm by weight of dry treated rice hulls.

3. The process of claim 2, wherein the non-siliceous inorganic flux constituents are reduced to not more than about 500 ppm by weight of dry treated rice hulls.

4. The process of claim 1, wherein the aqueous oxidative treatment is selected from the group consisting of an aqueous peroxide treatment, an aqueous acid treatment, an aqueous chelation treatment, and a combination thereof, provided that flux removal remains a safety constraint and is not used as a tunable variable for selecting a surface-area plateau.

5. The process of claim 1, wherein the entrained-flow oxidation reactor is configured to maintain particulate dispersion during oxidative burning and to provide a furnace residence time of from about 0.1 second to about 120 seconds.

6. The process of claim 1, wherein the excess air is selected such that combustion in the furnace is oxidative and furnace temperature is governed by excess-air flow while avoiding flux-induced sintering, catalytic crystallization, uncontrolled pore collapse, and crystallization to cristobalite or tridymite.

7. The process of claim 1, wherein the oxidative-agent intensity in the secondary calcination is set by oxidant concentration, oxidant partial pressure, oxidant feed rate, or combinations thereof, and corresponds to an oxygen concentration of from about 5 vol% to about 100 vol% in the secondary calcination atmosphere.

8. The process of claim 1, wherein the thermal residence time of the secondary calcination is from about 1 minute to about 6 hours.

9. The process of claim 1, wherein the secondary calcination produces a silica having a BET surface area of from about 200 m²/g to about 500 m²/g, a residual carbon content of from about 0.001% to about 5% by weight, and preserved amorphous character with mesopore structure retained against uncontrolled pore collapse.

10. A method for selecting a temperature-history-dependent surface-area plateau of porous amorphous biogenic silica produced from treated rice hulls, comprising:
(a) operating an entrained-flow oxidation reactor under excess air to burn flux-removed treated rice hulls and form silica ash containing residual carbon;
(b) subjecting the silica ash to secondary calcination under an oxygen-containing atmosphere; and
(c) selecting a temperature history for the reactor and the secondary calcination such that the silica reaches a temperature-history-dependent BET surface-area plateau,
wherein the plateau is governed by a two-factor plateau model comprising bulk reactor temperature and local molecular-level temperature spikes caused by residual carbon burning in intimate contact with silica.

11. The method of claim 10, wherein the BET surface-area plateau is within a range of about 200 m²/g to about 500 m²/g.

12. The method of claim 10, wherein the temperature history is defined by one or more of ramp rate, peak temperature, hold time, air-flow rate, oxidative-agent intensity during secondary calcination, particulate loading, quench rate, and residence time in the entrained-flow oxidation reactor.

13. The method of claim 10, wherein the bulk reactor temperature is from about 500°C to about 700°C.

14. The method of claim 10, wherein the local molecular-level temperature spikes are reduced by lowering residual carbon present in intimate contact with silica before completion of the secondary calcination, thereby maintaining a plateau signature comprising preserved pore volume and avoided abrupt surface-area collapse at a fixed bulk furnace temperature.

15. The method of claim 10, wherein the selected plateau is achieved independently of tuning the amount of non-siliceous inorganic flux constituents once the flux-removal safety constraint has been satisfied.

16. A method for controlling carbon-pathway partitioning during production of porous amorphous biogenic silica from treated rice hulls, comprising:
(a) burning flux-removed treated rice hulls in an entrained-flow oxidation reactor under excess air to form silica ash containing residual carbon; and
(b) performing secondary calcination of the silica ash in an oxygen-containing atmosphere while controlling thermal residence time,
wherein carbon-pathway partitioning is controlled between an oxidative depolymerization pathway and in-situ combustion, and
wherein increasing oxidative-agent intensity or thermal residence time shifts carbon removal toward oxidative depolymerization and away from in-situ combustion in intimate contact with silica.

17. The method of claim 16, wherein in-situ combustion comprises burning residual carbon while the residual carbon remains in intimate contact with silica, thereby creating local molecular-level temperature spikes that contribute to the two-factor plateau model.

18. The method of claim 16, wherein the thermal residence time during secondary calcination is selected from about 1 minute to about 6 hours.

19. The method of claim 16, wherein controlling carbon-pathway partitioning provides a carbon-pathway signature comprising lowered residual carbon content with preserved amorphous character, pore volume, and mesopore structure of the silica.

20. The method of claim 16, wherein the resulting silica has a residual carbon content of not more than about 5% by weight.

21. A porous amorphous biogenic silica product formed from treated rice hulls, the product having:
(a) a BET surface area within a temperature-history-dependent plateau of about 200 m²/g to about 500 m²/g;
(b) an amorphous structure;
(c) a non-siliceous inorganic flux content satisfying a flux-removal safety constraint; and
(d) a dispersibility continuum extending from an as-produced state through a mechanically dispersed state and an in-compound dispersed state,
wherein the product exhibits in-compound breakup under compounding shear.

22. The product of claim 21, wherein the non-siliceous inorganic flux content is not more than about 1,000 ppm by weight.

23. The product of claim 21, wherein the product has a pore volume of from about 0.1 cc/g to about 0.5 cc/g and an average pore diameter of from about 2 nm to about 15 nm.

24. The product of claim 21, wherein the product has a residual carbon content of from about 0.001% to about 5% by weight.

25. The product of claim 21, wherein the product comprises primary particles, weakly bound agglomerates, or both, such that the product undergoes further breakup during compounding in a rubber, polymer, coating, adhesive, or sealant matrix.

26. The product of claim 21, wherein the product, when compounded into an elastomer under mixing shear, attains a dispersion grade of at least about 70% as measured by ASTM D7723 or an equivalent method.
